(19) United States
(12) Patent Application Publication
(10) Pub. No.: US 2014/0282669 A1
(43) Pub. Date: Sep. 18, 2014

(54) METHODS AND APPARATUS TO IDENTIFY COMPANION MEDIA INTERACTION

(71) Applicant: F. Gavin McMillan, Tarpon Springs, FL (US)

(72) Inventor: F. Gavin McMillan, Tarpon Springs, FL (US)

(21) Appl. No.: 13/840,941

(22) Filed: Mar. 15, 2013

(51) Int. Cl. H04N 21/442

(52) U.S. Cl. CPC H04N 21/44213
USPC 725/19

(57) ABSTRACT

Methods, apparatus, systems and articles of manufacture are disclosed to identify companion media interaction. An example method includes identifying primary media corresponding to a primary media presentation generated by a primary media device of an environment. The example method also includes determining whether secondary media corresponding to secondary media device usage in the environment is related to the primary media.

### FIELD OF THE DISCLOSURE

This disclosure relates generally to audience measurement and, more particularly, to methods and apparatus to identify companion media interaction.

### BACKGROUND

Audience measurement of media (e.g., any type of content and/or advertisements such as broadcast television and/or radio, stored audio and/or video played back from a memory such as a digital video recorder or a digital video disc, a webpage, audio and/or video presented (e.g., streamed) via the Internet, a video game, etc.) often involves collection of media identifying data (e.g., signature(s), fingerprint(s), code(s), tuned channel identification information, time of exposure information, etc.) and people data (e.g., user identifiers, demographic data associated with audience members, etc.). The media identifying data and the people data can be combined to generate, for example, media exposure data indicative of amount(s) and/or type(s) of people that were exposed to specific piece(s) of media.

In some audience measurement systems, the people data is collected by capturing a series of images of a media exposure environment (e.g., a television room, a family room, a living room, a bar, a restaurant, etc.) and analyzing the images to determine, for example, an identity of one or more persons present in the media exposure environment, an amount of people present in the media exposure environment during one or more times and/or periods of time, etc. The collected people data can be correlated with media identifying information corresponding to media detected as being presented in the media exposure environment to provide exposure data (e.g., ratings data) for that media.

### BRIEF DESCRIPTION OF THE DRAWINGS

FIG. 1 is an illustration of an example media exposure environment including an example audience measurement device constructed in accordance with the teachings of this disclosure.

FIG. 2A is a block diagram of an example implementation of the example usage monitor of FIG. 1.

FIG. 2B is a block diagram of an example implementation of the example audience measurement device of FIG. 1.

FIG. 2C is a block diagram of an example implementation of the example engagement tracker of FIG. 2B.

FIG. 3 is an illustration of an example usage packet utilized by the example audience measurement device of FIGS. 1, 2A and/or 2B.

FIG. 4 is a flowchart representation of example machine readable instructions that may be executed to implement the usage monitor of FIGS. 1 and/or 2A.

FIG. 5 is a flowchart representation of example machine readable instructions that may be executed to implement the audience measurement device of FIGS. 1 and/or 2B.

FIG. 6 is a flowchart representation of example machine readable instructions that may be executed to implement the engagement tracker of FIGS. 2B and/or 2C.

FIG. 7A is an example table that may be calculated by the example engagement function calculator of FIG. 2C.

FIG. 7B is an example graph that may be generated by the example engagement function calculator of FIG. 2C.

FIG. 8A is another example table that may be calculated by the example engagement function calculator of FIG. 2C.

FIG. 8B is another example graph that may be generated by the example engagement function calculator of FIG. 2C.

FIG. 9A is another example table that may be calculated by the example engagement function calculator of FIG. 2C.

FIG. 9B is another example graph that may be generated by the example engagement function calculator of FIG. 2C.

FIG. 10A is another example table that may be calculated by the example engagement function calculator of FIG. 2C.

FIG. 10B is another example graph that may be generated by the example engagement function calculator of FIG. 2C.

FIG. 11 is a block diagram of an example processing platform capable of executing the example machine readable instructions of FIG. 4 to implement the example usage monitor of FIGS. 1 and/or 2A, executing the example machine readable instructions of FIG. 5 to implement the example audience measurement device of FIGS. 1 and/or 2B, and/or for executing the example machine readable instructions of FIG. 6 to implement the example engagement tracker of FIGS. 2B and/or 2C.

### DETAILED DESCRIPTION

In some audience measurement systems, people data is collected for a media exposure environment (e.g., a television room, a family room, a living room, a bar, a restaurant, a store, a cafeteria, etc.) by capturing a series of images of the environment and analyzing the images to determine, for example, an identity of one or more persons present in the media exposure environment, an amount of people present in the media exposure environment during one or more times and/or periods of time, etc. Audience measurement systems also detect media identifying information indicative of particular media being presented in the environment by a media presentation device such as, for example, a television. Media presented in the environment by a primary media presentation device, such as a television, is referred to herein as primary media. The people data can be correlated with the media identifying information corresponding to the primary media to provide, for example, exposure and/or ratings data for the primary media. For example, an audience measurement entity (e.g., The Nielsen Company (US), LLC) can calculate ratings for a first piece of primary media (e.g., a television program) by correlating data collected from a plurality of panelist sites with the demographics of the panelists at those sites. For example, for each panelist site wherein the first piece of primary media is detected in the monitored environment at a first time, media identifying information for the first piece of primary media is correlated with presence information detected in the environment at the first time. The data and/or results from multiple panelist sites are combined and/or analyzed to provide ratings representative of exposure of a population as a whole.

Secondary media devices (e.g., tablets, mobile phones, laptops, etc.) enable users to access secondary media in addition to the primary media presented by a primary media device (e.g., a television). In some situations, accessing secondary media (e.g., an application, a website or data stream via the Internet, music, etc.) via the secondary media device(s) distracts (e.g., reduces an amount of attention or focus of) a user from the primary piece of media (e.g., a television program, an advertisement, etc.). For example, the panelist in the media exposure environment may be playing a game (e.g., Solitaire, Ticket to Ride™, Catan™, etc.) on a tablet or a smart phone while watching a sporting event on a television. Alternatively, the panelist may be browsing the Internet on a laptop computer rather than watching an on-demand program being presented by the television. In such instances, the television is referred to herein as a primary media device and the tablet, mobile phone and/or laptop computer are referred to herein as secondary media devices(s). In such a scenario, the sporting event is referred to as the primary media and the game is referred to as secondary media. While the above example refers to a television as a primary media device, examples disclosed herein can be utilized with additional or alternative types of media presentation devices serving as the primary media device and/or the secondary media device.

While some interactions with secondary media devices involve exposure to media unrelated to the primary media, in some instances, the user uses the secondary media device to interact with secondary media related to the primary media during presentation of the primary media. For example, the secondary media device may be presenting a webpage or executing an application that is associated with the primary media during presentation of the primary media. Such secondary media that is associated and/or related to the primary media is referred to herein as companion media. That is, companion media is media (e.g., an application, a program, music, a website, a data stream, an advertisement, etc.) meant to be accessed via a secondary media device in connection with (e.g., simultaneously with) particular primary media presented by a primary media device. Secondary media unrelated to the primary media is sometimes referred to herein as non-companion media. The term “secondary media” is generic to both companion media and non-companion media presented on a secondary media device.

In some examples, operation of the companion media is driven by the primary media. In such instances, an application implementing (e.g., presenting) the companion media on the secondary media device detects data (e.g., audio signatures, watermarks, codes, etc.) in the currently playing primary media to identify the primary media and/or to receive instruction(s) from the primary media. Using the detected data in the primary media, the application implementing the companion media presents certain information to a user of the secondary media device. For example, a companion application on a secondary media device may identify (e.g., by detecting a code in an audio signal) a particular television show and/or a scene of the television show being presented by a primary media device. In response to such an identification, the companion application presents companion media related to the television show to make available information about a product or service associated with the identified television show. For example, the companion application (e.g., being executed on a tablet) may display “Ryan is wearing a sweater from The Gap” while a television in the same environment as the tablet is presenting a scene from a television program in which the character Ryan appears in the presentation. In some examples, companion media is used to disseminate advertisements (e.g., related to the primary media). For example, a companion website accessed via the tablet displays “If you like Coke as much as Ryan does, touch here to receive a Buy One Get One Free coupon for a 20 ounce Coke!” in real-time (e.g., at substantially the same time) that Ryan drinks a Coke in the scene presented by the television. In some examples, companion media is used to survey audience members. For example, a companion piece of media prompts the audience member to answer a question after presenting a scene from a television program, such as “Do you think Ryan was right for breaking up with Susan?” A system for providing companion media is described by Harness et al. in U.S. patent application Ser. No. 12/771,640, filed on Apr. 30, 2010, which is hereby incorporated by reference in its entirety.

Examples disclosed herein recognize that use of secondary media devices to interact with non-companion media is indicative of a reduced level of engagement with the primary media (e.g., relative to a level of engagement which would occur without the interaction with the secondary media) and, in the extreme, with no engagement with the primary media. Further, examples disclosed herein recognize that use of secondary devices to interact with companion media is indicative of a heightened or increased level of engagement with the primary media (e.g., relative to a level of engagement without the interaction with the secondary media). Accordingly, examples disclosed herein monitor media exposure environments for an audience member interaction with a secondary media device during presentation of primary media and determine a type for the detected interaction. In particular, examples disclosed herein determine whether the interaction with the secondary media device corresponds to interaction with companion media or non-companion media. Some examples disclosed herein utilize the identified type of interaction by generating exposure data (e.g., statistics and/or measurements of engagement) for a concurrently presented piece of primary media and/or the secondary media accessed via the secondary media device. For example, media exposure information for a piece of media generated by examples disclosed herein indicates an impact of the detected interaction with the secondary media on the level of engagement paid to the piece of primary media.

Examples disclosed herein detect companion media interaction by comparing detected media identifying information associated with primary media with usage information collected from secondary media devices. As disclosed in detail below, examples disclosed herein detect or otherwise obtain first media identifier(s) associated with the primary media and second media identifier(s) associated with secondary media being presented via a secondary media device at a similar time as a presentation of the primary media. Examples disclosed herein determine whether the first media identifier(s) are associated with the second media identifier(s) to determine whether a detected interaction with the secondary media device is a companion interaction or a non-companion interaction.

As an illustrative example, an example media provider elects to utilize companion media (e.g., via a specific application for a primary piece of media, via a generic application including a library of primary media, etc.) along with primary media. In such instances, the media provider may want to generate actual and/or expected performance data (e.g., statistics, ratings, etc.) in connection with, for example, the companion media, the primary media, a combination of the companion media and the primary media, and/or any other desired performance data. Examples disclosed herein enable generation of such performance data by, for example, monitoring environments for secondary media device usage and for media identifying information associated with primary media. In particular, examples disclosed herein may collect signature(s), fingerprint(s), code(s), tuned channel identification information, time of exposure information, etc. to identify primary media. Additionally or alternatively, examples disclosed herein collect people data, such as user identifiers, demographic data associated with audience members, etc. during presentation of the primary media in the environment. When examples disclosed detect an interaction with a secondary media device, information regarding the corresponding secondary media is collected by, for example, instructing and/or requesting the secondary media device to collect and/or transmit user identification information and/or media identifying information associated with the secondary media (e.g., a Uniform Resource Locator (URL) for a web page being viewed by the audience member, an application on the secondary device being accessed by the audience member, etc.) to, for example, a central data collection facility. In some examples, the information regarding the secondary media is directly detected by, for example, monitoring the environment for signature(s), fingerprint(s), watermark(s), code(s), etc. capable of identifying the secondary media. In other examples, the secondary media is detected by an on-device meter resident on the secondary media device.

Examples disclosed herein use the collected information (e.g., media identifier(s) associated with the primary media and media identifier(s) associated with the secondary media) to classify the secondary media device usage as related to or unrelated to the primary media identified. That is, examples disclosed herein determine whether the secondary media device is being used to interact with companion media or non-companion media. Some examples disclosed herein compare the primary media identifying information with the secondary media identifying information to determine whether the secondary media is related to the primary media. Additionally or alternatively, examples disclosed herein compare the secondary media identifying information to known companion media for the primary media to determine whether the secondary media is related to the primary media (e.g., via a lookup table).

FIG. 1 illustrates an example media exposure environment 100 including an information presentation device 102, a multimodal sensor 104, and a meter 106 for collecting audience measurement data. In the illustrated example of FIG. 1, the media exposure environment 100 is a room of a household (e.g., a room in a home of a panelist such as the home of a “Nielsen family”) that has been statistically selected to develop media ratings data for a geographic location, a market, and/or a population/demographic of interest. In the illustrated example, one or more persons of the household have registered with an audience measurement entity (e.g., by agreeing to be a panelist) and have provided their demographic information to the audience measurement entity as part of a registration process to enable associating demographics with viewing activities (e.g., media exposure).

In the illustrated example of FIG. 1, the multimodal sensor 104 is placed above the information presentation device 102 at a position for capturing image and/or audio data of the media exposure environment 100. In some examples, the multimodal sensor 104 is positioned beneath or to a side of the information presentation device 102 (e.g., a television or other display). In the illustrated example of FIG. 1, the example information presentation device 102 is referred to as a primary media device because the information presentation device (in this example, a television) is fixed in the example environment and intended to be the focal media presentation device for the corresponding room. As such, the multimodal sensor 104 is configured to primarily monitor the media exposure environment 100 relative to the information presentation device 102. However, the example multimodal sensor 104 can be utilized to monitor additional or alternative media presentation device(s) of the environment 100.

As described in detail below, the example meter 106 of FIG. 1 utilizes the multimodal sensor 104 to capture a plurality of time stamped frames of visual image data (e.g., via a two-dimensional camera) and/or depth data (e.g., via a depth sensor) from the environment 100 in order to perform people monitoring (e.g., to identify persons and/or number of persons in the audience). In the example of FIG. 1, the multimodal sensor 104 of FIG. 1 is part of a video game system 108 (e.g., Microsoft® XBOX®, Microsoft® Kinect®). However, the example multimodal sensor 104 can be associated and/or integrated with a set-top box (STB) located in the environment 100, associated and/or integrated with the information presentation device 102, associated and/or integrated with a Blu-ray® player located in the environment 100, or can be a standalone device (e.g., a Kinect® sensor bar, a dedicated audience measurement meter, etc.), and/or otherwise implemented. In some examples, the meter 106 is integrated in an STB or is a separate standalone device and the multimodal sensor 104 is the Kinect® sensor or another sensing device.

In some examples, the audience measurement entity provides the multimodal sensor 104 to the household. In some examples, the multimodal sensor 104 is a component of a media presentation system purchased by the household such as, for example, a camera of the video game system 108 (e.g., Microsoft® Kinect®) and/or piece(s) of equipment associated with the video game system 108 (e.g., a Kinect® sensor). In such examples, the multimodal sensor 104 may be repurposed and/or data collected by the image capturing device 104 may be repurposed for audience measurement. In some examples, the multimodal sensor 104 is integrated with the video game system 108. For example, the multimodal sensor 104 may collect image data (e.g., three-dimensional data and/or two-dimensional data) using one or more sensors for use with the video game system 108 and/or may also collect such image data for use by the meter 106. In some examples, the multimodal sensor 104 employs a first type of image sensor (e.g., a camera) to obtain image data of a first type (e.g., two-dimensional data) and a second type of image sensor (e.g., a depth sensor) to collect a second type of image data (e.g., three-dimensional data). In illustrated example, the multimodal sensor 104 also includes audio capturing component(s) such as, for example, a directional microphone to collect audio data presented in the environment 100. In some examples, only one type of sensor is provided by the video game system 108 and a second sensor is added by an audience measurement system including the meter 106.

To capture depth data, the example multimodal sensor 104 of FIG. 1 uses a laser or a laser array to project a dot pattern onto the environment 100. Depth data collected by the multimodal sensor 104 can be interpreted and/or processed based on the dot pattern and how the dot pattern lays onto objects of the environment 100. In the illustrated example of FIG. 1, the multimodal sensor 104 also captures two-dimensional image data via one or more cameras (e.g., infrared sensors) capturing images of the environment 100. In some examples, the example multimodal sensor 104 of FIG. 1 is capable of detecting some or all of eye position(s) and/or movement(s), skeletal profile(s), pose(s), posture(s), body position(s), person identit(ies), body type(s), etc. of the individual audience members. In some examples, the data detected via the multimodal sensor 104 is used to, for example, determine that an audience member is interacting with a secondary media device.

In some examples, the example meter 106 is also adapted to collect media identifying information in order to identify primary media presented by the primary media presentation device 102. As explained below in connection with FIG. 2B, the identification of the primary media may be performed by the meter 106 to, for example, collect code, signatures and/or tuning information.

The example media exposure environment 100 of FIG. 1 includes a secondary media device 112 (e.g., a tablet or a smart phone) with which an audience member 110 is interacting. In the illustrated example of FIG. 1, the secondary media device 112 includes an example usage monitor 114. In the illustrated example of FIG. 1, the usage monitor 114 collects secondary media device usage information, generates a usage packet based on the usage information, and provides the usage packet to the meter 106. For example, the usage monitor 114 of FIG. 1 collects user identifying information, media identifying information associated with media accessed via the secondary media device, media device usage start times and/or stop times (e.g., corresponding to particular instances of particular applications and/or pieces of media), media device usage duration information, etc. In some examples, the audience measurement entity provides the usage monitor 114 to the household by, for example, making the usage monitor 114 available for download over a network and/or installing the usage monitor 114 on the secondary media device 112. For example, the usage monitor 114 of FIG. 1 identifies a primary or designated user for the secondary media device 112 that is typically used by a single user (e.g., a smart phone). In other examples, the usage monitor 114 passively detects the secondary media device usage information using one or more automated techniques (e.g., via sensor(s) of the tablet to capture an image of the user, biometric or physical data corresponding to the user, usage patterns, and/or techniques of the user, etc.). Additionally or alternatively, the example usage monitor 114 of FIG. 1 actively collects user identifying information by requesting feedback from the user. Active collection of user identifying information is advantageous when, for example, the secondary media device 112 is one that is used by multiple people of the household, such as a laptop computer, a desktop computer, a tablet, etc.

The example usage monitor 114 of FIG. 1 collects data indicative of which media is being currently presented and/or interacted with on the secondary media device 112. For example, the usage monitor 114 of FIG. 1 collects and/or identifies media requests made via the secondary media device 112. In such instances, the example usage monitor 114 of FIG. 1 monitors communications, instructions and/or requests made by the secondary media device 112, for example, at an operating system level of the secondary media device 112. Additionally or alternatively, the example usage monitor 114 of FIG. 1 monitors network traffic (e.g., HTTP requests) and detects, for example, websites accessed by the secondary media device 112. Additionally or alternatively, the example usage monitor 114 of FIG. 1 detects media identifying information (e.g., signature(s), watermark(s), code(s), fingerprint(s), etc.) associated with currently playing media. Additionally or alternatively, the example usage monitor 114 of FIG. 1 receives media identifying information from instance(s) of media being presented on the secondary media device 112. For example, companion media may be adapted to communicate and/or otherwise provide usage information (e.g., metadata such as media identifier(s)) to the example usage monitor 114 of FIG. 1 when the companion media is accessed via a secondary media device (e.g., the secondary media device 112 of FIG. 1). The example usage monitor 114 of FIG. 1 uses any additional or alternative technique(s) and/or mechanism(s) to identify media being accessed via the secondary media device 112.

As described in detail below, the example usage monitor 114 of FIG. 1 communicates data (e.g., media identifier(s), application identifier(s), timestamp(s), etc.) indicative of secondary media accessed on the secondary media device 112 to the example meter 106 of FIG. 1. For example, the example usage monitor 114 of FIG. 1 periodically and/or aperiodically transmits a message having a payload of media identifying information to the meter 106. Additionally or alternatively, the example usage monitor 114 transmits the data to the meter 106 in response to queries from the meter 106, which periodically and/or aperiodically polls the environment 100 for usage information from, for example, the usage monitor 114 and/or any other suitable source (e.g., using usage monitors resident on other secondary media device(s)).

In some examples, the secondary media device 112 does not include the usage monitor 114 of FIG. 1. In such instances, certain secondary media (e.g., companion media and/or companion applications) may be adapted to include identifying information (e.g., code(s) embedded in audio data) that is detectable by, for example the meter 106 of FIG. 1. An example implementation of the example meter 106 of FIG. 1 and a collection of such media identifying information is described in detail below in connection with FIG. 2. Additionally or alternatively, certain secondary media may be adapted to instruct the secondary media device 112 to store identifying information in response to the secondary media being accessed. In such instances, the example meter 106 can query the secondary media device 112 for data and/or the example secondary media device 112 can automatically transmit data to the example meter 106.

In some examples, the usage monitor 114 is additionally or alternatively tasked with detecting primary media presentation in the media exposure environment 100. For example, the usage monitor 114 of FIG. 1 may utilize sensor(s) (e.g., microphone(s)) of the secondary media device 112 to collect and/or detect audio signatures, watermarks, etc. presented by the primary information presentation device 102 of FIG. 1. In some examples, the usage monitor 114 includes a media detection component such as the example media detector described in greater detail below in connection with FIG. 2. In some such examples, the usage monitor 114 provides data regarding detection(s) of primary media to the example meter 106. In some examples, the meter 106 does not itself monitor for media identifying data corresponding to primary media output by the primary media presentation device, but instead may only collect people data as explained above.

As described below, the example meter 106 of FIG. 1 associates usage data of the secondary media device 112 with primary media detection(s) to, for example, enable generation of exposure data (e.g., ratings information) and/or engagement level data for the corresponding primary media. For example, when the example meter 106 of FIG. 1 determines that the audience member 110 is interacting with the secondary media device 112 concurrently (e.g., at substantially the same time) with a presentation of primary media, the example meter 106 of FIG. 1 determines whether the secondary media device 112 is presenting companion media or non-companion media. Thus, the example meter 106 of FIG. 1 determines, for example, a level of engagement for the primary media based on which type of interaction (e.g., companion or non-companion) is occurring with the secondary media device 112 and/or an impact on the level of engagement for the primary media based on which type of interaction is occurring with the secondary media device 112.

In the illustrated example of FIG. 1, the meter 106 utilizes the multimodal sensor 104 to identify audience members, detect an interaction with the secondary media device 112, detect primary media, and/or detect any other suitable aspect or characteristic of the environment 100. In some examples, the multimodal sensor 104 is integrated with the video game system 108. For example, the multimodal sensor 104 may collect image data (e.g., three-dimensional data and/or two-dimensional data) using one or more sensors for use with the video game system 108 and/or may also collect such image data for use by the meter 106. In some examples, the multimodal sensor 104 employs a first type of image sensor (e.g., a two-dimensional sensor) to obtain image data of a first type (e.g., two-dimensional data) and collects a second type of image data (e.g., three-dimensional data) from a second type of image sensor (e.g., a three-dimensional sensor). In some examples, only one type of sensor is provided by the video game system 108 and a second sensor is added by a different component of the audience measurement system (e.g., a sensor associated with the example meter 106).

In the example of FIG. 1, the meter 106 is a software meter provided for collecting and/or analyzing data from, for example, the multimodal sensor 104 and/or the secondary media device 112 and/or for collecting and/or analyzing other media identification data. In some examples, the meter 106 is installed in the video game system 108 (e.g., by being downloaded to the same from a network, by being installed at the time of manufacture, by being installed via a port (e.g., a universal serial bus (USB) from a jump drive provided by the audience measurement entity, by being installed from a storage disc (e.g., an optical disc such as a Blu-ray disc, Digital Versatile Disc (DVD) or CD (compact Disk), or by some other installation approach). Executing the meter 106 on the panelist's equipment is advantageous in that it reduces the costs of installation by relieving the audience measurement entity of the need to supply hardware to the monitored household). In other examples, rather than installing the software meter 106 on the panelist's consumer electronics, the meter 106 is a dedicated audience measurement unit provided by the audience measurement entity. In such examples, the meter 106 may include its own housing, processor, memory and software to perform the desired audience measurement functions. In some such examples, the meter 106 is adapted to communicate with the multimodal sensor 104 via a wired or wireless connection. In some such examples, the communications are affected via the panelist's consumer electronics (e.g., via a video game console). In other example, the multimodal sensor 104 is dedicated to audience measurement and, thus, the consumer electronics owned by the panelist are not utilized for the monitoring functions.

In some examples, the meter 106 is installed in the secondary media device 112 (e.g., by being downloaded to the same from a network, by being installed at the time of manufacture, by being installed via a port (e.g., a universal serial bus (USB) from a jump drive provided by the audience measurement entity), by being installed from a storage disc (e.g., an optical disc such as a Blu-ray disc, Digital Versatile Disc (DVD) or compact Disk (CD), or by some other installation approach). In some such examples, the meter 106 is adapted to utilize any sensors native or available to the secondary media device 112. For example, the meter 106 may collect audio data and/or image data in the media exposure environment 100 via one or more sensors (e.g., microphone(s), image and/or video camera(s), etc.) included in the secondary media device 112 to identify primary media in the media exposure environment 100 while the usage monitor 114 identifies secondary media being accessed via the secondary media device 112.

The example audience measurement system of FIG. 1 can be implemented in additional and/or alternative types of environments such as, for example, a room in a non-statistically selected household, a theater, a restaurant, a tavern, a store, an arena, etc. For example, the environment may not be associated with a panelist of an audience measurement study, but instead may simply be an environment associated with a purchased XBOX® and/or Kinect® system.

In the illustrated example of FIG. 1, the primary media device 102 (e.g., a television) is coupled to a set-top box (STB) that implements a digital video recorder (DVR) and/or a digital versatile disc (DVD) player. Alternatively, the DVR and/or DVD player may be separate from the STB. In some examples, the meter 106 of FIG. 1 is installed (e.g., downloaded to and executed on) and/or otherwise integrated with the STB. Moreover, the example meter 106 of FIG. 1 can be implemented in connection with additional and/or alternative types of media presentation devices such as, for example, a radio, a computer display, a video game console and/or any other communication device able to present content to one or more individuals via any past, present or future device(s), medium(s), and/or protocol(s) (e.g., broadcast television, analog television, digital television, satellite broadcast, Internet, cable, etc.).

FIG. 2A is a block diagram of an example implementation of the example usage monitor 114 of FIG. 1. In the illustrated example of FIG. 2A, the usage monitor 114 includes a data communicator 224, a usage detector 226, a packet populator 228, a usage time stamper 230 and a secondary media identification database 232. The example usage monitor 114 includes a usage detector 226 to identify when a user is interacting with secondary media. As described below, the example usage monitor 114 provides a usage packet to the meter 106 to process and determine whether a detected interaction with a secondary media device 112 is a companion interaction or a non-companion interaction.

The data communicator 224 of the illustrated example of FIG. 2A is implemented by a wireless communicator, to allow the usage monitor 114 to communicate with a wireless network (e.g., a Wi-Fi network). However, additionally or alternatively, the data communicator 224 may be implemented by any other type of network interface such as, for example, an Ethernet interface, a cellular interface, a Bluetooth interface, etc.

In the illustrated example of FIG. 2A, the usage detector 226 detects interactions of audience members (e.g., the audience member 110 of FIG. 1) with secondary media devices (e.g., the example secondary media device 112 of FIG. 1). For example, the usage detector 226 may monitor device status (e.g., on, off, idol, activated, etc.), communications, instructions and/or requests made by the secondary media device 112, network traffic, media identifying information (e.g., signature(s), watermark(s), code(s), fingerprint(s), etc.) associated with secondary media usage, etc. When the usage detector 226 detects secondary media device usage, the usage detector 226 collects monitoring information for the secondary media. For example, the usage detector 226 may identify a secondary media identifier. To this end, in some examples, the usage detector 226 queries a secondary media identification database 232 to determine a secondary media identifier corresponding to the content of the monitoring information collected. In some examples, the usage monitor 114 maintains its own secondary media identification database that is periodically and/or aperiodically updated to add, remove and/or modify secondary media identification entries. Additionally or alternatively, the example usage detector 226 may query an external secondary media identification database (e.g., via the data communicator 224) to determine a secondary media identifier corresponding to the content of the monitoring information. In addition, the usage detector 226 may identify a user identifier and usage data associated with the secondary media usage. In some examples, the usage detector 226 identifies the user identifier based on the secondary media device 112. For example, the usage detector 226 may prompt the user for feedback for the secondary media device 112 that may be shared by multiple people (e.g., a laptop computer, a desktop computer, a tablet, etc.). Additionally or alternatively, the secondary media device 112 may be assigned a user identifier. For example, secondary media usage on a secondary media device such as a mobile phone that is not typically shared between people may associate the secondary media usage with the assigned user identifier.

In the illustrated example of FIG. 2A, the packet populator 228 populates a usage packet to transmit to the meter 106 with the collected monitoring information. For example, the packet populator 228 populates the usage packet with the secondary media identifier, user identifier, usage data, etc. The usage packet is time stamped by the usage time stamper 230 and transmitted via the data communicator 224 to the meter 106.

The usage time stamper 230 of the illustrated example includes a clock and a calendar. The example time stamper 210 associates a time period (e.g., 1:00 a.m. Central Standard Time (CST) to 1:01 a.m. CST) and date (e.g., Jan. 1, 2013) with each usage packet by, for example, appending the period of time and date information to an end of the data into the usage package.

The secondary media identification database 232 may include a volatile memory (e.g., Synchronous Dynamic Random Access Memory (SDRAM), Dynamic Random Access Memory (DRAM), RAMBUS Dynamic Random Access Memory (RDRAM, etc.) and/or a non-volatile memory (e.g., flash memory). The secondary media identification database 232 may include one or more double data rate (DDR) memories, such as DDR, DDR2, DDR3, mobile DDR (mDDR), etc. The secondary media identification database 232 may additionally or alternatively include one or more mass storage devices such as, for example, hard drive disk(s), compact disk drive(s), digital versatile disk drive(s), etc.

While an example manner of implementing the usage monitor 114 of FIG. 1 is illustrated in FIG. 2A, one or more of the elements, processes and/or devices illustrated in FIG. 2A may be combined, divided, re-arranged, omitted, eliminated and/or implemented in any other way. Further, the example usage detector 226, the example packet populator 228, the example usage time stamper 230, the example secondary media identification database 232 and/or, more generally, the example usage monitor 114 of FIG. 2A may be implemented by hardware, software, firmware and/or any combination of hardware, software and/or firmware. Thus, for example, any of the example usage detector 226, the example packet populator 228, the example usage time stamper 230, the example secondary media identification database 232 and/or, more generally, the example usage monitor 114 of FIG. 2A could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example usage detector 226, the example packet populator 228, the example usage time stamper 230, the example secondary media identification database 232 and/or, more generally, the example usage monitor 114 is/are hereby expressly defined to include a tangible computer readable storage device or storage disk such as a memory, a digital versatile disk (DVD), a compact disk (CD), a Blu-ray disk, etc. storing the software and/or firmware. Further still, the example usage monitor 114 of FIG. 1 may include one or more elements, processes and/or devices in addition to, or instead of, those illustrated in FIG. 2A, and/or may include more than one of any or all of the illustrated elements, processes and devices.

FIG. 2B is a block diagram of an example implementation of the example meter 106 of FIG. 1. The example meter 106 of FIG. 2B includes an audience detector 200 to develop audience composition information regarding audience member(s) (e.g., the audience member 110 of FIG. 1). In particular, the example audience detector 200 of FIG. 2B detects people in the monitored environment and identifies interactions of one or more of the people with secondary media devices, such as the example secondary media device 112 of FIG. 1. As described below, the example audience detector 200 determines whether a detected interaction with a secondary media device 112 is a companion interaction or a non-companion interaction and classifies the interaction accordingly.

In the illustrated example of FIG. 2B, the audience detector 200 includes a people analyzer 204. The example meter 106 of FIG. 2B also includes a media detector 202 to collect primary media information regarding, for example, media presented in the media exposure environment 100 of FIG. 1. The example meter 106 includes an interface 201, a device interaction tracker 208, a time stamper 210, a memory 212 and out output device 214.

The interface 201 of the illustrated example of FIG. 2B is implemented by a wireless communicator, to allow the usage monitor 114 to communicate with a wireless network (e.g., a Wi-Fi network). However, additionally or alternatively, the interface 201 may be implemented by any other type of network interface such as, for example, an Ethernet interface, a cellular interface, a Bluetooth interface, etc.

In the illustrated example of FIG. 2B, the media detector 202 detects presentation(s) of primary media in the media exposure environment 100 and/or collects primary media identification information associated with the detected presentation(s) (e.g., a presentation of primary media by the primary media device 102 of FIG. 1). For example, the media detector 202, which may be in wired and/or wireless communication with the primary media device 102, the multimodal sensor 104, the video game system 108, the STB, and/or any other component(s) of a monitored entertainment system, collects, generates and/or extracts media identification information and/or source identification information for a media presentation. The media identifying information and/or the source identification data may be utilized to identify the program (e.g., primary media) by, for example, cross-referencing a program guide configured, for example, as a lookup table. In such instances, the source identification data may be, for example, the identity of a channel (e.g., obtained by monitoring a tuner of an STB or a digital selection made via a remote control signal) currently being presented on the primary media device 102. In some such examples, the time of detection as recorded by the time stamper 210 is employed to facilitate the identification of the primary media by cross-referencing a program table identifying broadcast media by distribution channel and time of broadcast.

Additionally or alternatively, the example media detector 202 can identify the presentation by detecting codes (e.g., watermarks) embedded with or otherwise conveyed (e.g., broadcast) with primary media being presented via an STB and/or the primary media device 102. As used herein, a code is an identifier that is transmitted with the primary media for the purpose of identifying and/or for tuning to (e.g., via a packet identifier header and/or other data used to tune or select packets in a multiplexed stream of packets) the corresponding primary media. Codes may be carried in the audio, in the video, in metadata, in a vertical blanking interval, in a program guide, in content data, or in any other portion of the primary media and/or the signal carrying the primary media. In the illustrated example, the media detector 202 extracts the codes from the primary media. In some examples, the media detector 202 may collect samples of the primary media and export the samples to a remote site for detection of the code(s).

Additionally or alternatively, the media detector 202 can collect a signature representative of a portion of the primary media. As used herein, a signature is a representation of some characteristic of signal(s) carrying or representing one or more aspects of the media (e.g., a frequency spectrum of an audio signal). Signatures may be thought of as fingerprints of the primary media. Collected signature(s) can be compared against a collection of reference signatures of known primary media to identify the tuned primary media. In some examples, the signature(s) are generated by the media detector 202. Additionally or alternatively, the media detector 202 may collect samples of the primary media and export the samples to a remote site for generation of the signature(s). In the example of FIG. 2B, irrespective of the manner in which the primary media of the presentation is identified (e.g., based on tuning data, metadata, codes, watermarks, and/or signatures), the media identification information and/or the source identification information is time stamped by the time stamper 210 and stored in the memory 212. In the illustrated example of FIG. 2B, the media identification information is provided to the device interaction tracker 208.

In the illustrated example of FIG. 2B, data obtained and/or generated by the multimodal sensor 104 of FIG. 1, such as image data and/or audio data is made available to the example meter 106 and stored in the memory 212. Further, the data received from the multimodal sensor 104 of FIG. 1 is time stamped by the time stamper 210 and made available to the people analyzer 204. The example people analyzer 204 of FIG. 2B generates a people count or tally representative of a number of people in the media exposure environment 100 for a frame of captured image data. The rate at which the example people analyzer 204 generates people counts is configurable. In the illustrated example of FIG. 2B, the example people analyzer 204 instructs the example multimodal sensor 104 to capture image data and/or audio data representative of the media exposure environment 100 in real-time (e.g., virtually simultaneously with) as the primary media device 102 presents the particular media. However, the example people analyzer 204 can receive and/or analyze data at any suitable rate.

The example people analyzer 204 of FIG. 2B determines how many people appear in a video frame in any suitable manner using any suitable technique. For example, the people analyzer 204 of FIG. 2B recognizes a general shape of a human body and/or a human body part, such as a head and/or torso. Additionally or alternatively, the example people analyzer 204 of FIG. 2B may count a number of “blobs” that appear in the video frame and count each distinct blob as a person. Recognizing human shapes and counting “blobs” are illustrative examples and the people analyzer 204 of FIG. 2B can count people using any number of additional and/or alternative techniques. An example manner of counting people is described by Ramaswamy et al. in U.S. patent application Ser. No. 10/538,483, filed on Dec. 11, 2002, now U.S. Pat. No. 7,203,338, which is hereby incorporated herein by reference in its entirety. In some examples, to determine the number of detected people in a room, the example people analyzer 204 of FIG. 2B also tracks a position (e.g., an X-Y coordinate) of each detected person.

Additionally, the example people analyzer 204 of FIG. 2B executes a facial recognition procedure such that people captured in the video frames can be individually identified. To identify people in the video frames, the example people analyzer 204 includes or has access to a collection (e.g., stored in a database) of facial signatures (e.g., image vectors). Each facial signature of the illustrated example corresponds to a person having a known identity to the people analyzer 204. The collection includes a facial identifier (ID) for each known facial signature that corresponds to a known person. For example, the collection of facial signatures may correspond to frequent visitors and/or members of the household associated with the example media exposure environment 100. The example people analyzer 204 of FIG. 2B analyzes one or more regions of a frame thought to correspond to a human face and develops a pattern or map for the region(s) (e.g., using depth data provided by the multimodal sensor 104). The pattern or map of the region represents a facial signature of the detected human face. In some examples, the pattern or map is mathematically represented by one or more vectors. The example people analyzer 204 of FIG. 2B compares the detected facial signature to entries of the facial signature collection. When a match is found, the example people analyzer 204 has successfully identified at least one person in the video frame. In such instances, the example people analyzer 204 of FIG. 2B records (e.g., in a memory 212 accessible to the people analyzer 204) the ID associated with the matching facial signature of the collection. When a match is not found, the example people analyzer 204 of FIG. 2B retries the comparison or prompts the audience for information that can be added to the collection of known facial signatures for the unmatched face. More than one signature may correspond to the same face (i.e., the face of the same person). For example, a person may have one facial signature when wearing glasses and another when not wearing glasses. A person may have one facial signature with a beard, and another when cleanly shaven.

In some examples, each entry of the collection of known people used by the example people analyzer 204 of FIG. 2B also includes a type for the corresponding known person. For example, the entries of the collection may indicate that a first known person is a child of a certain age and/or age range and that a second known person is an adult of a certain age and/or age range. In instances in which the example people analyzer 204 of FIG. 2B is unable to determine a specific identity of a detected person, the example people analyzer 204 of FIG. 2B estimates a type for the unrecognized person(s) detected in the exposure environment 100. For example, the people analyzer 204 of FIG. 2B estimates that a first unrecognized person is a child, that a second unrecognized person is an adult, and that a third unrecognized person is a teenager. The example people analyzer 204 of FIG. 2B bases these estimations on any suitable factor(s) such as, for example, height, head size, body proportion(s), etc.

Although the illustrated example uses image recognition to attempt to recognize audience members, some examples do not attempt to recognize the audience members. Instead, audience members are periodically or aperiodically prompted to self-identify. U.S. Pat. No. 7,203,338 discussed above is an example of such a system.

The example people analyzer 204 of FIG. 2B includes an interaction detector 206 to detect interactions of audience members (e.g., the audience member 110 of FIG. 1) with secondary media devices (e.g., the example secondary media device 112 of FIG. 1). The example interaction detector 206 of FIG. 2B analyzes image data (e.g., two-dimensional data and/or three-dimensional data) provided by the example multimodal sensor 104 of FIG. 1 to determine whether the audience member 110 is interacting with the secondary media device 112. In some examples, the interaction detector 206 compares the image data and/or an object outline detected in the image data to reference shapes known to correspond to a person interacting with a secondary media device. Such reference shapes correspond to, for example, a person holding a tablet in front of a face, a person sitting down with a tablet on their lap, a person hunched over while sitting, the secondary media device 112 itself, etc. Additionally or alternatively, the example interaction detector 206 of FIG. 2B detects presence of a second audio signal (e.g., in addition to the primary media) in the environment 100 and attributes the second audio signal to the secondary media device 112. The example interaction detector 206 of FIG. 2B utilizes any additional or alternative technique(s) and/or mechanism(s) to detect an interaction with the secondary media device 112. In some instances, the example interaction detector 206 implements methods and apparatus disclosed in U.S. application Ser. No. 13/728,515 to detect an interaction with the secondary media device 112. U.S. application Ser. No. 13/728,515 was filed on Dec. 27, 2012, is entitled “Methods and Apparatus to Determine Engagement Levels of Audience Members,” and is incorporated herein by reference in its entirety. As disclosed in U.S. application Ser. No. 13/728,515, the example interaction detector 206 of FIG. 5 detects a glow generated by the example secondary media device 112 and/or a pattern of light projected onto the audience member 110 by the secondary media device 112 to identify an interaction of the audience member 110 with the secondary media device 112.

When the example interaction detector 206 determines that the audience member 110 is interacting with the secondary media device 112, an indication of the interaction detection is provided to the example device interaction tracker 208 of FIG. 2. The example device interaction tracker 208 determines a type of the detection interaction. In the illustrated example of FIG. 2B, the device interaction tracker 208 determines whether the secondary media device 112 is being used to access companion media or non-companion media with respect to primary media being presented in the media exposure environment 100 via the primary media device 102. In the illustrated example of FIG. 2B, the device interaction tracker 208 includes a packet detector 218, a synchronizer 220 and a classifier 222. In the illustrated example of FIG. 2B, the packet detector 218 facilitates communications with secondary media devices, such as the example secondary media device 112 of FIG. 1. As described above, the example secondary media device 112 of FIG. 1 includes the usage monitor 114 to identify usage of the secondary media device 112 and/or secondary media being accessed on the secondary media device 112. The example packet detector 218 of FIG. 2B receives information from the example usage monitor 114 and/or any other component and/or application of the secondary media device 112 that tracks and/or detects usage of the secondary media device 112 and/or secondary media being accessed via the secondary media device 112. In some examples, the interaction detector 206 may not indicate interaction to the device interaction tracker 208, but the packet detector 218 may receive a usage packet 300. In some such examples, the packet detector 218 processes the usage packet 300 similar to when the packet detector 218 receives an interaction indication.

FIG. 3 illustrates an example usage packet 300 generated by the example usage monitor 114 of FIG. 1 and/or FIG. 2A and received by the example packet detector 218 of FIG. 2. In the illustrated example of FIG. 3, the usage packet 300 provided by the usage monitor 114 includes a secondary media identifier 302, a user identifier 304, usage data 306, and a primary media identifier 308. In the illustrated example of FIG. 3, the usage packet 300 is recorded in the memory 212 and made available to, for example, the synchronizer 220. In the illustrated example, the secondary media identifier 302 corresponds to secondary media being accessed via the secondary media device 112 and includes, for example, a name associated with the media, a unique number assigned to the media, signature(s), watermark(s), code(s), and/or any other media identifying information gathered and/or generated by the example usage monitor 114 of FIG. 1 and/or FIG. 2A. The example usage identifier 304 of FIG. 3 corresponds to the current user of the secondary media device 112 and/or a person registered as the primary user of the secondary media device 112. The example usage data 306 of FIG. 3 includes a start time, a stop time, duration of use, a state of the secondary media device 112, and/or any other suitable information regarding the usage of the secondary media device 112. The example primary media identifier 308 of FIG. 3 includes media identifying information associated with primary media detected by the example usage monitor 114 of FIG. 1 and/or FIG. 2A when the usage monitor 114 is tasked with monitoring the environment 100 for primary media (e.g., media presented by the example primary media device 102 of FIG. 1). When the example usage monitor 114 of FIG. 1 and/or FIG. 2A is not tasked with such monitoring and/or does not detect primary media in connection with the secondary media corresponding to the secondary media identifier 302, the example primary media identifier 308 of FIG. 3 is left blank, assigned a null value and/or omitted.

In some examples, one or more of the fields 302, 304, 306, 308 of the example usage packet 300 of FIG. 3 are populated by the secondary media device 112 rather than the usage monitor 114 of FIG. 1 and/or FIG. 2A. For example, if the secondary media device 112 of FIG. 1 includes a media detection component, as described above in FIG. 1, the example primary media identifier 308 and/or the example secondary media identifier 302 may be populated by the secondary media device 112 (e.g., via an application dedicated to companion applications executing on the secondary media device 112). Additionally or alternatively, the example secondary media device 112 of FIG. 1 (rather than or in addition to the example usage monitor 114) populates the example user identifier 304 of the example usage packet 300 by, for example, obtaining a registered user name for the secondary media device 112.

In some examples, the usage packet 300 is encoded (e.g., by the usage monitor 114 and/or a communication interface of the secondary media device 112) using a different protocol (e.g., hypertext transfer protocol (HTTP), simple object access protocol (SOAP), etc.) than a protocol used by the example meter 106. In such instances, the example packet detector 218 decodes and/or translates the received usage packet 300 such that the data of the example usage packet 300 can be analyzed by, for example, the example synchronizer 220 of FIG. 2.

In some examples, the packet detector 218 may not detect a usage packet 300. For example, an audience member in the media exposure environment 100 may be engaged with primary media while not using a secondary media device. In some such instances, the example packet detector 218 may receive an indication from the interaction detector 206 indicating that no secondary media device usage was detected. In the illustrated example of FIG. 2B, the packet detector 218 may then generate a usage packet 300 and mark the secondary media identifier field 302, the user identifier field 304, the usage data field 306 and the companion media flag field 310 with a null value.

The example synchronizer 220 of FIG. 2B adds information to the example usage packet 300 of FIG. 3 when needed. As described above, the example primary media identifier 308 of the usage packet 300 may be populated by the usage monitor 114. In many instances, the example primary media identifier 308 is a null value (if, for example, the example usage monitor 114 is not tasked with monitoring the environment 100 for primary media). In such instances, the example synchronizer 220 of FIG. 2B combines information collected from the usage monitor 114 (or the secondary media device 112) and information collected and/or generated by the example meter 106. For example, the synchronizer 220 of FIG. 2B adds media identifying information collected by the media detector 202 of the meter 106 to the primary media identifier 308 of the example usage packet 300 of FIG. 3. In such instances, the example synchronizer 220 of FIG. 2B identifies first time information of the usage packet 300 (e.g., a time stamp in the usage data 306) and second time information of detected primary media (e.g., time stamps generated by the time stamper 210 for data collected by the media identifier 202). The example synchronizer 220 of FIG. 2B determines which primary media detected in the environment 100 was detected at a time corresponding to the first time information associated with the interaction with the secondary media device 112. The example synchronizer 220 of FIG. 2B populates the example primary media identifier 308 with the corresponding primary media. Accordingly, the example usage packet 300 of FIG. 3 includes the primary media identifier 306 and the secondary media identifier 302 which both correspond to a same time.

In some examples, the usage monitor 114 may incorrectly identify the primary media. For example, the usage monitor 114 may detect media that is emitted by a media presentation device in a different room than the primary media device 102. The ability of the media identifying meter to detect media being presented outside of the viewing and/or listening proximity of the panelist is referred to as “spillover” because the media being presented outside of the viewing and/or listening proximity of the panelist is “spilling over” into the area occupied by the media identifying meter and may not actually fall within the attention of the panelist. Such spillover events can be treated by adapting the techniques of U.S. patent application Ser. No. 13/782,895 filed on Mar. 1, 2013, and entitled “Methods and Systems for Reducing Spillover by Measuring a Crest Factor,” U.S. patent application Ser. No. 13/791,432 filed on Mar. 8, 2013, and entitled “Methods and Systems for Reducing Spillover by Detecting Signal Distortion,” U.S. patent application Ser. No. 13/801,176 filed on Mar. 13, 2013, and entitled “Methods and Systems for Reducing Spillover by Analyzing Sound Pressure Levels,” U.S. patent application Ser. No. 13/828,702 filed on Mar. 14, 2013, and entitled “Methods and Systems for Reducing Crediting Errors Due to Spillover Using Audio Codes and/or Signatures,” each of which is hereby incorporated by reference in its entirety, to two meters in the same room. In such circumstances, the techniques disclosed in U.S. patent application Ser. No. 13/782,895, U.S. patent application Ser. No. 13/791,432, U.S. patent application Ser. No. 13/801,176, U.S. patent application Ser. No. 13/828,702 may be used to prevent spillover from adversely affecting results of media monitoring.

In the illustrated example of FIG. 2B, the example classifier 222 determines whether secondary device usage detected in the media exposure environment 100 is related to primary media presentation by the primary media device 102. Using the secondary media identifier 302 included in the example usage packet 300, the example classifier 222 determines whether the secondary device usage is related to the primary media associated with the example primary media identifier 308 of the example usage packet 300 (e.g., corresponds to companion media) or unrelated to the primary media associated with the example primary media identifier 308 of the example usage packet 300 (e.g., corresponds to non-companion media). In some examples, the classifier 222 of FIG. 2B uses a data structure, such as a lookup table, to determine whether the secondary device usage is related to the primary media. For example, the lookup table includes one or more instances of companion media for the primary media. The example classifier 222 of FIG. 2B queries such a lookup table with the secondary media identifier 302 to determine if the interaction corresponding to the example usage packet 300 of FIG. 3 is a companion interaction. If the secondary media identifier 302 is found in the portion of the lookup table associated with the detected primary media, the example classifier 222 of FIG. 2B marks the example usage packet 300 of FIG. 3 with a companion media flag 310 and/or positive value for the companion media flag 310. If the secondary media identifier 302 is not found in the portion of the lookup table associated with the detected primary media, the example classifier 222 of FIG. 2B does not mark the usage packet 300 with the companion media flag 310 and/or marks the companion media flag 310 with a negative value.

Additionally or alternatively, the example classifier 222 of FIG. 2B compares the secondary media identifier 302 to the primary media identifier 308 to determine whether a similarity exists. For example, the classifier 222 of FIG. 2B determines whether a characteristic (e.g., title, source, etc.) associated with the secondary media corresponding to the secondary media identifier 302 is substantially similar (e.g., within a similarity threshold) to a characteristic associated with the primary media corresponding to the primary media identifier 308. In the illustrated example, the classifier 222 of FIG. 2B determines that the secondary media of the example usage packet 300 is companion media when such a similarity exists between the characteristics and/or any other suitable aspect(s) of the secondary media and the primary media. Additional or alternative comparisons involving the media identifiers 302, 308 can be utilized to identify the secondary media as companion or non-companion media.

The example people analyzer 204 of FIG. 2B outputs the calculated tallies, identification information, person type estimations for unrecognized person(s), and/or corresponding image frames to the time stamper 210. Similarly, the example device interaction tracker 208 outputs data (e.g., usage packet(s), companion media interaction flag(s), etc.) to the time stamper 210. The time stamper 210 of the illustrated example includes a clock and a calendar. The example time stamper 210 associates a time period (e.g., 1:00 a.m. Central Standard Time (CST) to 1:01 a.m. CST) and date (e.g., Jan. 1, 2013) with each calculated people count, usage packet, identifier, video or image frame, behavior, engagement level, media selection, audio segment, code, system, etc., by, for example, appending the period of time and date information to an end of the data into a data package. In the illustrated example, the data package including the time stamp and the data is stored in the memory 212.

The memory 212 may include a volatile memory (e.g., Synchronous Dynamic Random Access Memory (SDRAM), Dynamic Random Access Memory (DRAM), RAMBUS Dynamic Random Access Memory (RDRAM, etc.) and/or a non-volatile memory (e.g., flash memory). The memory 212 may include one or more double data rate (DDR) memories, such as DDR, DDR2, DDR3, mobile DDR (mDDR), etc. The memory 212 may additionally or alternatively include one or more mass storage devices such as, for example, hard drive disk(s), compact disk drive(s), digital versatile disk drive(s), etc. When the example meter 106 is integrated into, for example the video game system 108 and/or secondary media device 112 of FIG. 1, the meter 106 may utilize memory of the video game system 108 and/or the secondary media device 112 to store information such as, for example, the people counts, the image data, the engagement levels, companion media interaction information, etc.

In the illustrated example of FIG. 2B, the output device 214 periodically and/or aperiodically exports data (e.g., media identification information, audience identification information, companion media interaction information, etc.) from the memory 214 to a data collection facility 216 via a network (e.g., a local-area network, a wide-area network, a metropolitan-area network, the Internet, a digital subscriber line (DSL) network, a cable network, a power line network, a wireless communication network, a wireless mobile phone network, a Wi-Fi network, etc.). In some examples, the example meter 106 utilizes the communication abilities (e.g., network connections) of the video game system 108 to convey information to, for example, the data collection facility 216. In the illustrated example of FIG. 2B, the data collection facility 216 is managed and/or owned by an audience measurement entity (e.g., The Nielsen Company (US), LLC). The example data collection facility 216 also includes an engagement tracker 240 to analyze the companion media interaction information generated by the device tracker 208. As described in greater detail below in connection with FIG. 2C, the example engagement tracker 240 analyzes the companion media interaction in conjunction with the media identifying data collected by the media detector 202 and/or the people tallies generated by the people analyzer 204 and/or the personal identifiers generated by the people analyzer 204 to generate, for example, exposure and/or engagement data. The information from many panelist locations may be compiled and analyzed to generate ratings representative of primary media exposure and companion media interaction via concurrent usage of a secondary media device by one or more populations of interest.

Alternatively, analysis of the data (e.g., data generated by the people analyzer 204, the device interaction tracker 208, and/or the media detector 202) may be performed locally (e.g., by the example meter 106 of FIG. 2) and exported via a network or the like to a data collection facility (e.g., the example data collection facility 216 of FIG. 2) for further processing. In some examples, additional information (e.g., demographic data associated with one or more people identified by the people analyzer 204, geographic data, etc.) is correlated with the exposure information, the companion media interaction information and/or the engagement information by the audience measurement entity associated with the data collection facility 216 to expand the usefulness of the data collected by the example meter 106 of FIGS. 1 and/or 2. The example data collection facility 216 of the illustrated example compiles data from a plurality of monitored exposure environments (e.g., other households, sports arenas, bars, restaurants, amusement parks, transportation environments, stores, etc.) and analyzes the data to generate exposure ratings and/or engagement information for geographic areas and/or demographic sets of interest.

While an example manner of implementing the meter 106 of FIG. 1 is illustrated in FIG. 2B, one or more of the elements, processes and/or devices illustrated in FIG. 2B may be combined, divided, re-arranged, omitted, eliminated and/or implemented in any other way. Further, the example audience detector 200, the example media detector 202, the example people analyzer 204, the example interaction detector 206, the example device interaction tracker 208, the example time stamper 210, the example packet detector 218, the example synchronizer 220, the example classifier 222 and/or, more generally, the example meter 106 of FIG. 2B may be implemented by hardware, software, firmware and/or any combination of hardware, software and/or firmware. Thus, for example, any of the example audience detector 200, the example media detector 202, the example people analyzer 204, the example interaction detector 206, the example device interaction tracker 208, the example time stamper 210, the example packet detector 218, the example synchronizer 220, the example classifier 222 and/or, more generally, the example meter 106 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example audience detector 200, the example media detector 202, the example people analyzer 204, the example interaction detector 206, the example device interaction tracker 208, the example time stamper 210, the example packet detector 218, the example synchronizer 220, the example classifier 222, and/or the example meter 106 is/are hereby expressly defined to include a tangible computer readable storage device or storage disk such as a memory, a digital versatile disk (DVD), a compact disk (CD), a Blu-ray disk, etc. storing the software and/or firmware. Further still, the example meter 106 of FIG. 1 may include one or more elements, processes and/or devices in addition to, or instead of, those illustrated in FIG. 2B, and/or may include more than one of any or all of the illustrated elements, processes and devices.

FIG. 2C is a block diagram of an example implementation of the example engagement tracker 240 of FIG. 2B. The example engagement tracker 240 of FIG. 2C includes an engagement ratings generator 242 to generate engagement ratings for media content detected by the example content detector 202 of FIG. 2B. As described above, information identifying the media content presented in the environment 100 and companion media interaction information detected at the time the identified media content was presented are conveyed to the data collection facility 216 of FIG. 2C. The example engagement ratings generator 242 of FIG. 2C assigns the companion media interaction information to the corresponding portion(s) of the detected media content to formulate engagement ratings for the media content and/or portion(s) thereof. That is, the example engagement ratings generator 242 generates data indicative of how attentive members of the audience 110 (e.g., individually and/or as a group) were with respect to the primary media device 102 when the audience was engaged in companion media usage, non-companion media usage and/or no secondary media device usage. In the illustrated example, the engagement ratings generator 242 generates engagement ratings for pieces of media content as a whole, such as an entire television show, using the companion media interaction information detected in the environment 100 throughout the presentation of the media content. In some examples, the engagement ratings are more granular and are assigned to different portions of the same media, thereby allowing determinations about the effectiveness of the companion media. In some examples, the engagement ratings are used to determine whether a retroactive fee is due to a service provider from an advertiser due to a certain companion media interaction existing at a time of presentation of content of the advertiser. Additionally or alternatively, the engagement ratings may be used to determine the effectiveness of companion media. In some examples, the results are provided in a report generated by the data collection facility 216.

Additionally or alternatively, the example engagement tracker 240 of FIG. 2C includes an engagement function calculator 244 to calculate an engagement function that varies over a period of time corresponding to a piece of media content. That is, the example engagement function calculator 244 determines how companion media interaction information provided by the example device interaction tracker 208 varies over the course of a presentation of primary media, such as a television show. For example, the engagement function calculator 244 may determine that a first companion media interaction of the audience 110 was detected during a first segment (e.g., a portion between commercial breaks) of a television show or a first scene of the television show. The example engagement function calculator 244 may also determine that a second companion media interaction of the audience 110 was detected during a second segment or a second scene of the television show. As the detected companion media interaction varies from segment to segment or scene to scene, the example engagement function calculator 244 formulates a function that tracks the changes of the companion media interaction. The resulting function can be paired with identifiable objects, events and/or other aspects of the media content to determine how attentive the audience 110 (individually or as a whole) was to the primary media device 102 with respect to companion media usage, non-companion media usage and/or no secondary media device usage.

The example engagement tracker 240 of FIG. 2C also includes a metric aggregator 246. The engagement ratings calculated by the example engagement ratings generator 242 and/or the engagement functions calculated by the example engagement function generator 244 for the environment 100 are aggregated with similar information collected at different environments (e.g., other living rooms). The example data collection facility 216 of FIG. 2B has access to statistical information associated with other environments, households, regions, demographics, etc. that the example metric aggregator 246 uses to generate cumulative statistics related to the companion media interaction information provided by the example device interaction tracker 208 and/or the example engagement tracker 240.

While an example manner of implementing the engagement tracker 240 of FIG. 2B is illustrated in FIG. 2C, one or more of the elements, processes and/or devices illustrated in FIG. 2C may be combined, divided, re-arranged, omitted, eliminated and/or implemented in any other way. Further, the example engagement ratings tracker 242, the example engagement function calculator 244, the example metric aggregator 246 and/or, more generally, the example engagement tracker 240 of FIG. 2C may be implemented by hardware, software, firmware and/or any combination of hardware, software and/or firmware. Thus, for example, any of the example engagement ratings tracker 242, the example engagement function calculator 244, the example metric aggregator 246 and/or, more generally, the example engagement tracker 240 of FIG. 2C could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example engagement ratings tracker 242, the example engagement function calculator 244, the example metric aggregator 246 and/or, more generally, the example engagement tracker 240 is/are hereby expressly defined to include a tangible computer readable storage device or storage disk such as a memory, a digital versatile disk (DVD), a compact disk (CD), a Blu-ray disk, etc. storing the software and/or firmware. Further still, the example engagement tracker 240 of FIG. 2B may include one or more elements, processes and/or devices in addition to, or instead of, those illustrated in FIG. 2C, and/or may include more than one of any or all of the illustrated elements, processes and devices.

FIG. 4 is a flowchart representative of example machine readable instructions for implementing the example usage monitor 114 of FIGS. 1 and/or 2A. FIG. 5 is a flowchart representative of example machine readable instructions for implementing the example meter 106 of FIGS. 1 and/or 2B. FIG. 6 is a flowchart representative of example machine readable instructions for implementing the example engagement tracker 240 of FIGS. 2B and/or 2C. In these examples, the machine readable instructions comprise a program for execution by a processor such as the processor 1112 shown in the example processor platform 1100 discussed below in connection with FIG. 11. The program may be embodied in software stored on a tangible computer readable storage medium such as a CD-ROM, a floppy disk, a hard drive, a digital versatile disk (DVD), a Blu-ray disk, or a memory associated with the processor 1112, but the entire program and/or parts thereof could alternatively be executed by a device other than the processor 1112 and/or embodied in firmware or dedicated hardware. Further, although the example program is described with reference to the flowcharts illustrated in FIGS. 4, 5 and 6, many other methods of implementing the example usage monitor 114, the example meter 106 and/or the example engagement tracker 240 may alternatively be used. For example, the order of execution of the blocks may be changed, and/or some of the blocks described may be changed, eliminated, or combined.

As mentioned above, the example processes of FIGS. 4, 5 and/or 6 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals. As used herein, “tangible computer readable storage medium” and “tangible machine readable storage medium” are used interchangeably. Additionally or alternatively, the example processes of FIGS. 4, 5 and/or 6 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable device or disk and to exclude propagating signals. As used herein, when the phrase “at least” is used as the transition term in a preamble of a claim, it is open-ended in the same manner as the term “comprising” is open ended.

The program of FIG. 4 begins with a detection of secondary media usage at the usage detector 226 of the usage monitor 114 of FIGS. 1 and/or 2A (block 402). The example usage detector 226 collects monitoring information from the detected secondary media (block 404). Using the collected monitoring information, the usage detector 226 queries the example secondary media identification database 232 for a secondary media identifier corresponding to the collected monitoring information (block 406). The example packet populator 228 populates a usage packet with the secondary media identifier and/or collected monitoring information (block 408). The example usage time stamper 230 time stamps the usage packet with a time period and date (block 410). The time stamped usage packet is transmitted to the meter 106 by the example usage time stamper 230 via, for example, the data communicator 224. Control then returns to block 402.

The program of FIG. 5 begins at block 502 at which the example meter 106 (FIG. 2) detects primary media presentation in a monitored environment. For example, the example media detector 202 (FIG. 2) detects an embedded watermark in primary media presented in the media exposure environment 100 (FIG. 1) by the primary media device 102 of FIG. 1 (e.g., a television), and identifies the primary media using the embedded watermark (e.g., by querying a database at the example data collection facility 216 (FIG. 2)). The example media detector 202 then sends the media identification information to the example device interaction tracker 208.

At block 504, the example device interaction tracker 208 determines whether a secondary media device is being utilized (or accessed) in the media exposure environment 100. For example, the example packet detector 218 (FIG. 2) may detect an example usage packet 300 provided by the secondary media device 112 of FIG. 1 (e.g., a tablet). If the example packet detector 218 does not detect a usage packet 300 sent by the secondary media device 112 (block 504), control proceeds to block 506 and the packet detector 218 generates a usage packet 300 and marks the companion media flag 310 null. In such examples, marking the companion media flag 310 null is indicative of, for example, an audience member (e.g., the audience member 110 of FIG. 1) watching a television program via the primary media device 102, while not concurrently using a secondary media device or accessing secondary media. Control then returns to block 502 to detect, for example, different primary media.

If the example packet detector 218 detects a usage packet 300 (block 504), control proceeds to block 508 and the example synchronizer 220 determines whether a primary media identifier 308 is included in the usage packet 300. For example, the usage monitor 114 may populate the primary media identifier 308 prior to sending the usage packet 300 to the meter 106. If the usage packet 300 does not include a primary media identifier 308 (block 508), at block 510, the synchronizer 220 adds the primary media identifier 308 from, for example, media identifying information detected and/or generated by the meter 106. Control then proceeds to block 512.

If the usage packet 300 includes the primary media identifier 308 (block 508) and/or the synchronizer 222 adds the primary media identifier 308, at block 512, the classifier 222 (FIG. 2) determines whether the secondary device usage is related to the primary media. For example, the example classifier 222 uses the primary media identifier 308 from the usage packet 300 to identify related secondary media in a lookup table. If the example classifier 222 finds a match (block 512), the classifier 222 marks the companion media flag 310 positive (block 516), and the example process 500 of FIG. 5 returns to block 502 to detect, for example, different primary media.

If the example classifier 222 does not find a related secondary media match for the secondary media identifier 302 (block 512), the classifier 222 marks the companion media flag 310 negative (block 514), and the example process 500 of FIG. 5 returns to block 502 to detect, for example, different primary media.

FIG. 6 begins with a receipt of data at the example engagement tracker 240 of FIG. 2C from one or more audience measurement devices (e.g., the meter 106 of FIGS. 1 and/or 2B (block 600). The engagement ratings generator 242 generates engagement ratings information for corresponding media content received in conjunction with the companion media interaction information (block 602). The example metric aggregator 246 aggregates the received companion media interaction information for one media exposure environment, such as a first room of a first house, with the received companion media interaction information for another media exposure environment, such as a second room of a second house or a second room of the first house (block 604). For example, the metric aggregator 246 calculates the total number of people accessing companion media while watching primary media, the total number of people accessing non-companion media while watching primary media, and the total number of people not using a secondary media device while watching primary media. The example engagement function calculator 244 generates one or more engagement functions for one or more of the piece(s) of media content received at the engagement tracker 240 (block 606).

FIG. 7A is an example table that may be generated by the example engagement function calculate 244. FIG. 7B is an example graph corresponding to the data included in the table of FIG. 7A. In the illustrated example of FIGS. 7A and 7B, the example engagement function calculator 244 correlates the total number of audience members using a companion application while viewing the primary media with ratings information for the primary media. In such examples, the effectiveness of companion media can be based on a comparison of the correlation between the number of viewers (e.g., ratings information) and total number of related companion media interactions. In some examples, companion media producers (or designers) may use high correlation between the ratings information and the total number of related companion media interactions to show value of their companion media.

FIG. 8A is another example table that may be generated by the example engagement function calculator 244. FIG. 8B is another example graph corresponding to the data included in the table of FIG. 8A. In the illustrated example of FIGS. 8A and 8B, the engagement function calculator 244 correlates the companion media interaction information over the course of a piece of primary media. In such examples, the effectiveness of the companion media can be based on a comparison of the level of engagement with the related second media over the course of the program. For example, analysis of the results may indicate users of particular companion media may become less engaged with the primary media over the course of the primary media relative to audience members who access non-companion media or do not utilize a secondary media device over the course of the primary media.

FIG. 9A is another example table that may be generated by the example engagement function calculator 244. FIG. 9B is another example graph corresponding to the data included in the table of FIG. 9A. In the illustrated example of FIGS. 9A and 9B, the engagement function calculator 244 may gather demographic information regarding the audience members and correlate the demographic information with the companion media interaction information in the different categories. In some such examples, the effectiveness of companion media can be based on a comparison of the distribution of the total number of people in each category across different demographic groups for a particular piece of media. Using the distribution of the total numbers across different demographic groups, an advertiser, for example, can better perform targeting of advertisements to users of the related secondary media. For example, younger females may be the primary users of companion media.

FIG. 10A is another example table that may be generated by the example engagement function calculator 244. FIG. 10B is another example graph corresponding to the data included in the table of FIG. 10A. In the illustrated example of FIGS. 10A and 10B, the engagement function calculator 244 tallies the total number of audience members in each aggregated metric over a period (e.g., a television season). In such examples, the data collection facility 216 compares the cumulative numbers for each metric to determine the effectiveness of companion media in attracting and/or retaining audience members. For example, the number of audience members accessing a companion application may increase as the television season progresses. The example of FIG. 6 then ends (block 608).

FIG. 11 is a block diagram of an example processor platform 1100 capable of executing the instructions of FIG. 4 to implement the example usage monitor 114 of FIGS. 1 and/or 2A, executing the instructions of FIG. 5 to implement the example meter 106 of FIGS. 1 and/or 2B and/or executing the instructions of FIG. 6 to implement the example data collection facility 216 of FIGS. 2B and/or 2C. The processor platform 1100 can be, for example, a server, a personal computer, a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, or any other type of computing device.

The processor platform 1100 of the illustrated example includes a processor 1112. The processor 1112 of the illustrated example is hardware. For example, the processor 1112 can be implemented by one or more integrated circuits, logic circuits, microprocessors or controllers from any desired family or manufacturer.

The processor 1112 of the illustrated example includes a local memory 1113 (e.g., a cache). The processor 1112 of the illustrated example is in communication with a main memory including a volatile memory 1114 and a non-volatile memory 1116 via a bus 1118. The volatile memory 1114 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1116 may be implemented by flash memory and/or any other desired type of memory device. Access to the main memory 1114, 1116 is controlled by a memory controller.

The processor platform 1100 of the illustrated example also includes an interface circuit 1120. The interface circuit 1120 may be implemented by any type of interface standard, such as an Ethernet interface, a universal serial bus (USB), and/or a PCI express interface.

In the illustrated example, one or more input devices 1122 are connected to the interface circuit 1120. The input device(s) 1122 permit(s) a user to enter data and commands into the processor 1112. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 1124 are also connected to the interface circuit 1120 of the illustrated example. The output devices 1124 can be implemented, for example, by display devices (e.g., a light emitting diode (LED), an organic light emitting diode (OLED), a liquid crystal display, a cathode ray tube display (CRT), a touchscreen, a tactile output device, a light emitting diode (LED), a printer and/or speakers). The interface circuit 1120 of the illustrated example, thus, typically includes a graphics driver card, a graphics driver chip or a graphics driver processor.

The interface circuit 1120 of the illustrated example also includes a communication device such as a transmitter, a receiver, a transceiver, a modem and/or network interface card to facilitate exchange of data with external machines (e.g., computing devices of any kind) via a network 1126 (e.g., an Ethernet connection, a digital subscriber line (DSL), a telephone line, coaxial cable, a cellular telephone system, etc.).

The processor platform 1100 of the illustrated example also includes one or more mass storage devices 1128 for storing software and/or data. Examples of such mass storage devices 1128 include floppy disk drives, hard drive disks, compact disk drives, Blu-ray disk drives, RAID systems, and digital versatile disk (DVD) drives.

The coded instructions 1132 of FIGS. 4, 5 and/or 6 may be stored in the mass storage device 1128, in the volatile memory 1114, in the non-volatile memory 1116, and/or on a removable tangible computer readable storage medium such as a CD or DVD.

Example methods, apparatus and articles of manufacture have been disclosed which integrate companion media usage information with exposure and/or ratings data information for primary media, and, thereby determine the effectiveness of the companion media.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A method of identifying companion media interaction, the method comprising:
identifying primary media corresponding to a primary media presentation generated by a primary media device of an environment; and
determining whether secondary media corresponding to secondary media device usage in the environment is related to the primary media.

2. A method as defined in claim 1, wherein identifying the primary media comprises detecting media identifying information indicative of the primary media at the secondary media device.

3. A method as defined in claim 2, wherein the secondary media device populates a usage packet with a primary media identifier associated with the primary media and a secondary media identifier corresponding to the secondary media device usage.

4. A method as defined in claim 3, wherein determining whether the secondary media device usage is related to the primary media comprises comparing the primary media identifier and the secondary media identifier.

5. A method as defined in claim 1, wherein the identifying the primary media comprises detecting media identifying information indicative of the primary media at a meter associated with the primary media device.

6. A method as defined in claim 1, wherein determining whether the secondary media device usage is related to the primary media comprises comparing the secondary media associated with the secondary media device usage to companion media for the primary media.

7. A method as defined in claim 1, further comprising correlating the secondary media device usage with audience measurement data associated with the primary media.

8. A method of identifying companion media interaction, the method comprising:
detecting a primary media identifier corresponding to a primary media presentation in an environment;
detecting a secondary media identifier corresponding to a secondary media presentation by a secondary media device in the environment;
classifying the secondary media as a companion media for the primary media when the primary media identifier and the secondary media identifier are related, and classifying the secondary media as a non-companion media when the primary media identifier and the secondary media identifier are not related.

9. A method as defined in claim 8, further comprising determining the primary media identifier and the secondary media identifier are related by determining whether the primary media identifier and the secondary media identifier have a characteristic in common.

10. A method as defined in claim 8, further comprising determining the primary media identifier and the secondary media identifier are related by comparing the secondary media identifier to reference companion media identifiers in a list of companion media associated with the primary media.

11. A method as defined in claim 8, wherein the secondary media device generates a usage packet including the primary media identifier and the secondary media identifier.

12. A method as defined in claim 8, further comprising correlating the classified user interaction with audience measurement data associated with the primary media.

13. An apparatus to identify companion media interaction for primary media in an environment comprising:
a packet detector to detect a usage packet, wherein the usage packet is to include a secondary media identifier for secondary media;
a synchronizer to identify a primary media identifier indicative of primary media in the environment; and
a classifier to classify the secondary media as companion media for the primary media when the secondary media identifier is related to the primary media identifier and to classify the secondary media as non-companion media for the primary media when the secondary media identifier is not related to the primary media identifier.

14. An apparatus as defined in claim 13, wherein the classifier is to determine whether the secondary media identifier and the primary media identifier are related by determining if the secondary media and the primary media have a characteristic in common.

15. An apparatus as defined in claim 13, wherein the synchronizer is to attempt to identify a primary media identifier included in the usage packet.

16. An apparatus as defined in claim 15, wherein the synchronizer is to add a primary media identifier to the usage packet if the attempt to identify fails.

17. An apparatus as defined in claim 16, wherein the synchronizer is to:
compare a timestamp included in the usage packet to a timestamp associated with the primary media; and
based on the comparison, add the primary media identifier to the usage packet.

18. An apparatus as defined in claim 13, further comprising an indication detector to detect secondary device usage in the environment.

19. An apparatus as defined in claim 18, wherein the indication detector is to indicate to the packet detector when no secondary media is detected.

20. An apparatus as defined in claim 13, further comprising a media detector to detect the primary media identifier, the media detector to provide the primary media identifier to the synchronizer.

21. A tangible computer readable storage medium comprising instructions that, when executed, cause a machine to at least:
identify primary media that is to correspond to a primary media presentation generated by a primary media device;
and
determine whether secondary media associated with secondary media device usage is related to the primary media.

22. A tangible computer readable storage medium as defined in claim 21, the instructions to cause the machine to correlate the secondary device usage with audience measurement data associated with the primary media.
